(19) United States
(12) Patent Application Publication
(10) Pub. No.: US 2023/0242117 A1
(43) Pub. Date: Aug. 3, 2023

(54) TRANSMISSION-DRIVEN GENERATOR ON AN ELECTRIC VEHICLE

(71) Applicant: Gregory Clarence Ettel, Glencoe, MN (US)

(72) Inventor: Gregory Clarence Ettel, Glencoe, MN (US)

(21) Appl. No.: 17/589,064

(22) Filed: Jan. 31, 2022

(51) Int. Cl. B60W 30/18; B60W 10/08; B60W 10/26; H02K 7/00

(52) U.S. Cl. CPC B60W 30/18127; B60W 10/08; B60W 10/26; H02K 7/006; B60W 2510/244

(57) ABSTRACT

An electric motor in an electric vehicle is powered by a battery and drives a transmission which, in turn, drives ground engaging elements of the vehicle. The transmission is also coupled through a controllable clutch to a generator which generates an output that is used to recharge the battery, as the transmission is rotating.

### BACKGROUND

Electric vehicles are currently in wide use. Such vehicles use an electric motor, powered by a battery, to drive a transmission which, in turn, drives the ground engaging elements (such as wheels) of the vehicle.

Needless to say, battery charging is an issue that many are attempting to address. Limitations on the battery life in an electric vehicle or the ability to charge the battery during vehicle operation, directly limit the range of the vehicle between charging operations.

In order to address battery life issues, some manufactures use the electric motor as both a motor and a generator. For example, when an operator presses an accelerator, the rotor of the electric motor is driven by the rotating magnetic field. However, when the operator removes his or her foot from the accelerator, the rotating magnetic field stops and the rotor spins faster than the magnetic field in the stator. The electric motor thus becomes a generator which generates power that is used to recharge the battery. This type of charging technique only charges the battery when the operator removes his or her foot from the accelerator or when braking is applied. Therefore, this limits battery charging and thus the range of the electric vehicle between charging operations.

The discussion above is merely provided for general background information and is not intended to be used as an aid in determining the scope of the claimed subject matter.

### SUMMARY

An electric motor in an electric vehicle is powered by a battery and drives a transmission which, in turn, drives ground engaging elements of the vehicle. The transmission is also coupled through a controllable clutch to a generator which generates an output that is used to recharge the battery, as the transmission is rotating.

This Summary is provided only to introduce some concepts in a simplified form. The concepts are further described below in the Detailed Description. This Summary is not intended to identify either key features or essential features of the claimed subject matter, nor is it intended to be used as an aid in determining the scope of the claimed subject matter. Further, the claimed subject matter is not limited to implementations that solve any or all disadvantages noted in the background.

### BRIEF DESCRIPTION OF THE DRAWINGS

FIG. 1 is a block diagram of one example of an electric vehicle.

FIG. 2 is flow diagram illustrating one example of the operation of the electric vehicle shown in FIG. 1.

### DETAILED DESCRIPTION

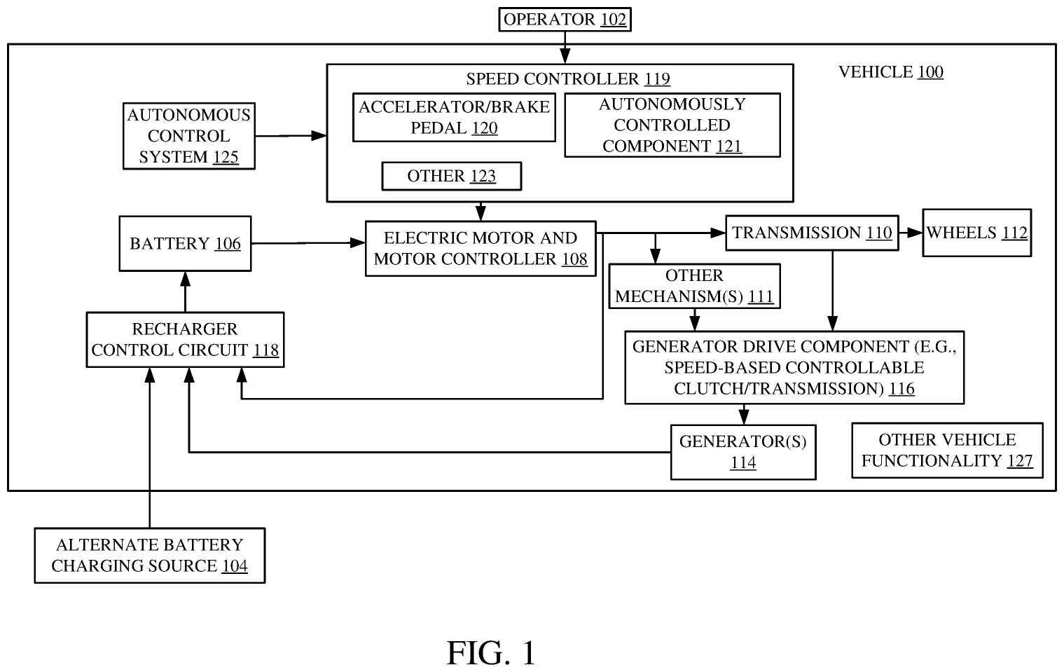

FIG. 1 is a block diagram of one example of an electric vehicle 100 that is shown being operated on by operator 102 and that is also shown as being configured to be coupled to an alternate battery charging source 104. In the example shown in FIG. 1, vehicle 100 includes a frame that carries battery 106 which is used to power electric motor and motor controller (motor) 108. The electric motor 108 has a drive shaft or other output mechanism that drives transmission 110 which, in turn, drives ground engaging elements (such as wheels) 112. The output of transmission 110 is also connected to drive generator 114 through a generator drive component (e.g., speed-based controllable clutch) 116. Generator 114, in turn, generates an output which can be used by recharger control circuit 118 to recharge battery 106.

The speed of motor 108 is controlled based on an output from a speed controller 119 which can include accelerator/brake pedal 120, autonomously controlled component 121, and/or other items 123. Operator 102 controls electric motor 108 through an accelerator/brake pedal or other interface mechanism 120. An autonomous control system 125 (such as a mapping system and an autonomous navigation and speed control system) can generate an output to autonomously controlled component 121 to automatically control the speed of motor 108. Vehicle 100 can include other vehicle functionality 127, such as a steering subsystem, and other functionality.

It can thus be seen that, whenever the output of electric motor 108 is turning, generator 114 is being driven to generate power that can be used to recharge battery 106. Therefore, when operator 102 is actuating the accelerator pedal 120, or when system 125 is actuating component 121, then transmission 110 drives generator 114 through clutch 116 to provide recharging power back to battery 106 through recharger control circuit 118. When the operator 102 de-actuates (e.g., removes his or her foot from) the accelerator pedal 120 or when subsystem 125 de-actuates component 121, then the output of electric motor 108 becomes a generator which, itself, generates electrical current that can be applied to recharger control circuit 118 for charging battery 106. It can thus be seen that, in the example shown in FIG. 1, recharger control circuit 118 is receiving recharge current which can be applied to recharge battery 106 regardless of whether operator 102 is actuating the accelerator pedal 120.

Electric motor 108 can be an alternating current (AC) motor or a direct current (DC) motor. When electric motor 108 is an AC motor, the regenerative feature of the AC motor can work as a generator, which brings power back to battery 106 through recharger control circuit 118. Motor 108 can be an induction motor or a synchronous motor. When electric motor 108 is an AC motor, it illustratively includes an AC inverter which converts the direct current power output from battery 108 to an alternating current.

Generator 114 can be a 10-kWh turbine generator (or another generator) that has a clutch 116 coupled to transmission 110. The output of motor 108 (or the output of transmission 110) can be used to rotate the turbine generator 114 that generates the electricity that can be used by recharger control circuit 118 to charge battery 106. The generator drive component (e.g., the controllable clutch or transmission) 116 regulates the speed of the turbine throughout the full range of the vehicle speed (or the speed of motor 108 and/or transmission 110). For instance, when transmission 110 is rotating more slowly, then clutch/transmission 116 shifts to run the turbine in generator 114 faster, and when transmission 110 is rotating more quickly, then the controllable clutch/transmission 116 shifts to run the turbine in generator 114, of a relatively constant speed, a speed within a predefined speed window, or otherwise as desired.

Recharger control circuit 118 can include one or more processors or controllers with associated memory, step up and/or step down transformers, sensors, voltage regulators, switches and other circuitry that can be used to apply the outputs from motor 108 and/or generator 114 to recharge the battery 106.

In addition, there may be times when battery 106 has an insufficient charge. At those times, battery 106 can be connected through recharger control circuit 118 to an alternate battery charging source 104. Source 104 may be such as an AC outlet, a charging station, etc.

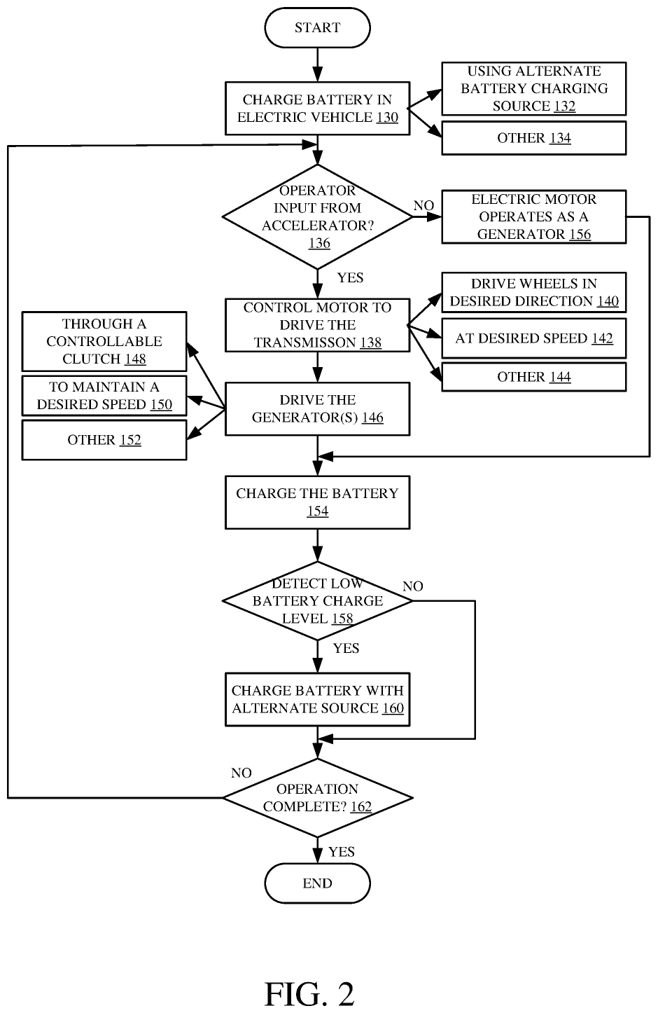

FIG. 2 is a flow diagram illustrating one example of the operation of vehicle 100 in maintaining a charge on battery 106. It is first assumed that battery 106 in vehicle 100 is charged, as indicated by block 130 in the flow diagram of FIG. 2. Battery 106 can be initially charged using an alternate battery charging source 104, as indicated by block 132, or in other ways, as indicated by block 134.

At some point, operator 102 will provide an input actuating accelerator 120, that will generate an input to electric motor and motor controller 108. The motor controller then controls motor 108 to drive transmission 110. Detecting the operator input on the accelerator is indicated by block 136 in the flow diagram of FIG. 2, and controlling the motor 108 to drive the transmission 110 is indicated by block 138.

In one example, the transmission 110 provides an output to drive wheels 112 (or other ground engaging elements) in the desired direction (such as forward or reverse), as indicated by block 140. The speed at which the motor 108 drive the transmission 110 (which drives wheels 112), is based upon the position of the accelerator 120, as indicated by block 142. The motor 108 can drive the transmission 110 in other ways as well, as indicated by block 144.

The transmission 110 also drives generator 114 to begin generating electricity, as indicated by block 146. In the example shown in FIG. 1, the transmission 110 drives generator 114 through the controllable clutch/transmission 116, as indicated by block 148, in order to maintain a desired drive speed of the turbine in generator 114, as indicated by block 150. The generator 114 can be driven by transmission 110 in other ways as well, as indicated by block 152.

The output of generator 114 is applied to recharger control circuit 118. Circuit 118 uses the output from generator 114 to recharge battery 106, as indicated by block 154 in the flow diagram of FIG. 2.

If, at block 136, it is determined that operator 102 has stopped actuating (e.g., removed his or her foot from) the accelerator 120, then the output of the electric motor 108 becomes a generator which can be provided back to recharger control circuit 118 to, again, charge battery 106. Operating motor 108 as a generator to recharge battery 106 as indicated by blocks 156 and 154 in the flow diagram of FIG. 2.

At some point, it may be that recharger control circuit 118 detects a low charge level on battery 106 (such as a battery level that falls below a threshold level), as indicated by block 158 in the flow diagram of FIG. 2. In that case, (where the battery level of battery 106 is low), then recharger control circuit 118 can operate to charge battery 106 with the alternate battery charging source 104, as indicated by block 160 in the flow diagram of FIG. 2. Recharging with an alternate source 104 may occur, for instance, by instructing operator 102 through an operator interface mechanism to connect battery 106 to an alternate battery charging source 104 though control circuit 118, or it may occur in other ways as well.

As long as operator 102 is operating the vehicle 100, as indicated by block 162 in the flow diagram of FIG. 2, operation reverts to block 136 where the state of the accelerator 120 is detected.

It should be noted that while the present description shows component 116 being driven by transmission 110, the generator can be driven by any other mechanism 111 that is powered by motor 108. This may include belts, chains, gears, other spinning shafts, etc. Also, while the present description describes a single generator 114, there may be multiple generators 114 of the same or different sizes, all driven by motor 108.

It can thus be seen that the present description describes a system in which the battery 106 in electric vehicle 100 is charged even while the electric motor 108 is driving a transmission 110. The motion of the transmission (or the output of electric motor 108) is used to turn a generator 114, through a clutch or transmission 116. The output of generator 114 can be used by a recharger control circuit 118 to charge battery 106. When the operator 102 de-activates (e.g., removes his or her foot from) the accelerator 120, the electric motor 108 becomes a generator and the output of motor 108 can be provided to charge battery 106. This can increase the operating range of the vehicle 100 because it increases the time during which battery 106 is being charged, during operation of vehicle 100.

The figures show a number of blocks with functionality ascribed to each block. It will be noted that fewer blocks can be used so the functionality is performed by fewer components. Also, more blocks can be used with functionality distributed among more components.

It should also be noted that the different examples described herein can be combined in different ways. That is, parts of one or more examples can be combined with parts of one or more other examples. All of this is contemplated herein.

Example 1 is an electric vehicle, comprising:

a ground engaging element that drives movement of the electric vehicle;

a battery;

an electric motor coupled to and powered by the battery and controlled to generate an output at a speed based on an input received from a speed controller;

a transmission coupled to the electric motor driving movement of the ground engaging element based on the output from the electric motor;

a generator actuated by the transmission to generate a first charging output when the electric motor is driving the transmission; and

a control circuit configured to receive the first charging output from the generator and charge the battery based on the first charging output received from the generator.

Example 2 is the electric vehicle of any or all previous examples wherein the electric motor is configured to generate a second charging output during coasting and braking of the electric vehicle.

Example 3 is the electric vehicle of any or all previous examples wherein the control circuit is configured to receive the second charging output from the electric motor and charge the battery based on the second charging output.

Example 4 is the electric vehicle of any or all previous examples and further comprising the speed controller wherein the speed controller comprises an operator input mechanism configured to receive an operator speed input and generate, as the input to the electric motor, a speed output based on the operator speed input.

Example 5 is the electric vehicle of any or all previous examples and further comprising the speed controller wherein the speed controller comprises an autonomously controlled component configured to receive a speed input from an autonomous control system and generate, as the input to the electric motor, a speed output based on the speed input from the autonomous control system.

Example 6 is the electric vehicle of any or all previous examples and further comprising:

a generator drive component wherein the generator is actuated by the transmission through the generator drive component.

Example 7 is the electric vehicle of any or all previous examples wherein the generator drive component comprises:

a speed-based controllable transmission configured to drive the generator at a desired speed.

Example 8 is the electric vehicle of any or all previous examples wherein the speed-based controllable transmission is configured to drive the generator at a speed within a predefined speed window.

Example 9 is the electric vehicle of any or all previous examples wherein the control circuit is configured to receive a third charging output from an alternate battery charging source and to charge the battery based on the third charging output.

Example 10 is a battery charging system on an electric vehicle, comprising:

a generator actuated by an electric motor in the electric vehicle to generate a first charging output when the electric motor in the electric vehicle is driving an output mechanism; and

a control circuit configured to receive the first charging output from the generator and provide a battery charging output to charge a battery based on the first charging output received from the generator.

The Example 11 is the battery charging system of any of all previous examples wherein the electric motor is configured to generate a second charging output during coasting and braking of the electric vehicle and wherein the control circuit is configured to receive the second charging output from the electric motor and charge the battery based on the second charging output.

Example 12 is the battery charging system of any or all previous examples and further comprising:

a speed controller wherein the speed controller comprises an operator input mechanism configured to receive an operator speed input and generate, as an input to the electric motor, a speed output based on the operator speed input the electric motor coupled to and powered by the battery and controlled to generate an output at a speed based on the speed output.

Example 13 is the battery charging system of any or all previous examples and further comprising:

a speed controller wherein the speed controller comprises wherein the speed controller comprises an autonomously controlled component configured to receive a speed input from an autonomous control system and generate, as the input to the electric motor, a speed output based on the speed input from the autonomous control system.

Example 14 is the battery charging system of any or all previous examples and further comprising:

a generator drive component wherein the generator is actuated by a transmission through the generator drive component.

Example 15 is the battery charging system of any or all previous examples wherein the generator drive component comprises:

a speed-based controllable transmission configured to drive the generator at a desired speed.

Example 16 is the battery charging system of any or all previous examples wherein the speed-based controllable transmission is configured to drive the generator at a speed within a predefined speed window.

Example 17 is the battery charging system of any or all previous examples wherein the control circuit is configured to receive a third charging output from an alternate battery charging source and to charge the battery based on the third charging output.

Example 18 is a method of controlling an electric vehicle, comprising:

actuating a generator with a transmission in the electric vehicle;

generating a first charging output with the generator when an electric motor in the electric vehicle is driving the transmission;

receiving the first charging output from the generator at a control circuit; and

providing a battery charging output to charge a battery based on the first charging output received from the generator.

Example 19 is the method of any or all previous examples and further comprising:

generating a second charging output during coasting and braking of the electric vehicle.

Example 20 is the method of any or all previous examples and further comprising:

providing a battery charging output to charge the battery based on the second charging output.

Although the present invention has been described with reference to preferred embodiments, workers skilled in the art will recognize that changes may be made in form and detail without departing from the spirit and scope of the invention.

What is claimed is:

1. An electric vehicle, comprising:
a ground engaging element that drives movement of the electric vehicle;
a battery;
an electric motor coupled to and powered by the battery and controlled to generate an output at a speed based on an input received from a speed controller;
a transmission coupled to the electric motor driving movement of the ground engaging element based on the output from the electric motor;
a generator actuated by the transmission to generate a first charging output when the electric motor is driving the transmission; and
a control circuit configured to receive the first charging output from the generator and charge the battery based on the first charging output received from the generator.

2. The electric vehicle of claim 1 wherein the electric motor is configured to generate a second charging output during coasting and braking of the electric vehicle.

3. The electric vehicle of claim 2 wherein the control circuit is configured to receive the second charging output from the electric motor and charge the battery based on the second charging output.

4. The electric vehicle of claim 1 and further comprising the speed controller wherein the speed controller comprises an operator input mechanism configured to receive an operator speed input and generate, as the input to the electric motor, a speed output based on the operator speed input.

5. The electric vehicle of claim 1 and further comprising the speed controller wherein the speed controller comprises an autonomously controlled component configured to receive a speed input from an autonomous control system and generate, as the input to the electric motor, a speed output based on the speed input from the autonomous control system.

6. The electric vehicle of claim 1 and further comprising:
a generator drive component wherein the generator is actuated by the transmission through the generator drive component.

7. The electric vehicle of claim 6 wherein the generator drive component comprises:
a speed-based controllable transmission configured to drive the generator at a desired speed.

8. The electric vehicle of claim 7 wherein the speed-based controllable transmission is configured to drive the generator at a speed within a predefined speed window.

9. The electric vehicle of claim 2 wherein the control circuit is configured to receive a third charging output from an alternate battery charging source and to charge the battery based on the third charging output.

10. A battery charging system on an electric vehicle, comprising:
a generator actuated by an electric motor in the electric vehicle to generate a first charging output when the electric motor in the electric vehicle is driving an output mechanism; and
a control circuit configured to receive the first charging output from the generator and provide a battery charging output to charge a battery based on the first charging output received from the generator.

11. The battery charging system of claim 10 wherein the electric motor is configured to generate a second charging output during coasting and braking of the electric vehicle and wherein the control circuit is configured to receive the second charging output from the electric motor and charge the battery based on the second charging output.

12. The battery charging system of claim 11 and further comprising:
a speed controller wherein the speed controller comprises an operator input mechanism configured to receive an operator speed input and generate, as an input to the electric motor, a speed output based on the operator speed input the electric motor coupled to and powered by the battery and controlled to generate an output at a speed based on the speed output.

13. The battery charging system of claim 11 and further comprising:
a speed controller wherein the speed controller comprises wherein the speed controller comprises an autonomously controlled component configured to receive a speed input from an autonomous control system and generate, as the input to the electric motor, a speed output based on the speed input from the autonomous control system.

14. The battery charging system of claim 11 and further comprising:
a generator drive component wherein the generator is actuated by a transmission through the generator drive component.

15. The battery charging system of claim 14 wherein the generator drive component comprises:
a speed-based controllable transmission configured to drive the generator at a desired speed.

16. The battery charging system of claim 15 wherein the speed-based controllable transmission is configured to drive the generator at a speed within a predefined speed window.

17. The battery charging system of claim 15 wherein the control circuit is configured to receive a third charging output from an alternate battery charging source and to charge the battery based on the third charging output.

18. A method of controlling an electric vehicle, comprising:
actuating a generator with a transmission in the electric vehicle;
generating a first charging output with the generator when an electric motor in the electric vehicle is driving the transmission;
receiving the first charging output from the generator at a control circuit; and
providing a battery charging output to charge a battery based on the first charging output received from the generator.

19. The method of claim 18 and further comprising:
generating a second charging output during coasting and braking of the electric vehicle.

20. The method of claim 18 and further comprising:
providing a battery charging output to charge the battery based on the second charging output.
